(19) United States
(12) Patent Application Publication
(10) Pub. No.: US 2014/0028953 A1
(43) Pub. Date: Jan. 30, 2014

(54) LIQUID CRYSTAL DISPLAY DEVICE

(71) Applicants: Hidenao Kubota, Ibaraki (JP); Satoshi Ouchi, Tokyo (JP)

(72) Inventors: Hidenao Kubota, Ibaraki (JP); Satoshi Ouchi, Tokyo (JP)

(21) Appl. No.: 13/980,441

(22) PCT Filed: Jan. 26, 2011
(86) PCT No.: PCT/JP2011/051476

§ 371 Date: Oct. 2, 2013

(51) Int. Cl. G02F 1/1335

(52) U.S. Cl. CPC G02F 1/133603
USPC 349/62

(57) ABSTRACT

An objective of the present invention is to enable making a liquid crystal display device thin, and to enable regional control of window brightness with power conservation. A backlight of a liquid crystal display device comprises a plate-shaped light guiding plate (20). Recesses (21) are formed on the light guiding plate (20), and LEDs (30) are housed in the recesses (21). The LEDs (30) further comprise light emitting faces (301) and rear faces. The rear faces of the LEDs (30) are brought into contact with the interior walls of the recesses (21) of the light guiding plate, and light that leaks from the rear faces of the LEDs (30) is proactively used. A resin (25) for optical coupling is positioned between the LEDs (30) and the interior faces of the recesses (21). Using the light from the rear faces of the LEDs (30) allows reducing the number of LEDs that need to be lit, allowing obtaining a liquid crystal display device with minimized power consumption.

### TECHNICAL FIELD

The present invention relates to a liquid crystal display device using LEDs for a backlight, and more particularly to a liquid crystal display device including a backlight in a configuration in which light from LEDs is changed into planar light using a light guiding plate.

### BACKGROUND ART

A liquid crystal display device includes a TFT substrate having pixel electrodes, thin film transistors (TFT), and the like formed in a matrix configuration and a counter substrate provided opposite to the TFT substrate in which color filters or the like are formed at locations corresponding to the pixel electrodes of the TFT substrate, and liquid crystals are sandwiched between the TFT substrate and the counter substrate. Images are formed by controlling the transmittance of light caused by liquid crystal molecules for every pixel.

Since the thickness and weight of the liquid crystal display device can be reduced, the liquid crystal display device is used in various fields. Since liquid crystals do not spontaneously emit light, a backlight is disposed on the back face of a liquid crystal display panel. For liquid crystal display devices having a relatively large screen such as a television set, a fluorescent tube has been used for a backlight. However, the fluorescent tube puts a heavy load on an earth environment because the fluorescent tube includes mercury steam, and the use of the fluorescent tube tends to be prohibited particularly in Europe, for example.

Therefore, an LED (a light emitting diode) is used for a light source for a backlight instead of the fluorescent tube. Liquid crystal display devices using an LED light source increase year after year also in large-sized display devices such as a TV set. Although the backlight of the liquid crystal display device is necessary to be a surface light source, the LED is a point light source. Therefore, it is necessary to provide an optical system that forms a surface light source using LEDs of point light sources.

“Patent Document 1” describes a configuration in which a light guiding plate is formed directly below a liquid crystal display panel, recesses are formed in lines on the light guiding plate, and LEDs are disposed on the recesses in lines. Namely, the configuration of “Patent Document 1” describes a configuration in which an optical component that emits light from the LEDs through the side surface is used, a diffuse reflection region 41DR having a diffuse reflection effect and a regular reflection region 41R having a regular reflection effect are formed on a reflective sheet unit, and the light is intentionally diffuse-reflected at a predetermined ratio, so that the use efficiency of light is improved and measures are taken against a brightness variation.

### RELATED ART DOCUMENT

### Patent Document

Patent Document 1: Japanese Patent Application Laid-Open Publication No. 2006-236701

### SUMMARY OF THE INVENTION

### Problems that the Invention is to Solve

In the technique described in “Patent Document 1”, it is necessary to form the diffuse reflection region 41DR having a diffuse reflection effect and the regular reflection region 41R having a regular reflection effect on the reflective sheet unit, and complicated optical design is needed. Moreover, in the technique described in “Patent Document 1”, a surface light source is formed by simultaneously lighting all of the LEDs and simultaneously using the overall light guiding plate, and no description is provided for a so-called region control in which some of the LEDs and a part of the light guiding plate are used to apply backlight onto a necessary portion on a screen.

So-called region control is performed to enable the application of backlight onto only a necessary region and to avoid lighting of LEDs on portions for no use, so that power consumption can be reduced, and screen contrast can be improved. For a configuration in which region control can be performed and a thickness of a light guiding plate can be reduced, a configuration as illustrated in FIG. 18, which is an exploded perspective view, is considered. In FIG. 18, a wedge-shaped light guiding plate 50 exists on a circuit board 31 mounted with a plurality of LEDs 30 to be a light source, and an optical sheet group 16 formed of three diffusion films 15 is disposed on the wedge-shaped light guiding plate 50. A liquid crystal display panel 10 configured of a TFT substrate 11, a counter substrate 12, an upper polarizer 13, and a lower polarizer 14 is disposed on the optical sheet group 16.

The wedge-shaped light guiding plate 50 illustrated in FIG. 18 is formed of four divided light guiding plates 53, and the divided light guiding plate 53 is formed of four light guiding plate blocks 51. The divided light guiding plate 53 is divided into the light guiding plate blocks 51 by grooves 52. A predetermined number of the LEDs 30 corresponds to each of the light guiding plate blocks 51, and the LEDs 30 are controlled for every light guiding plate block 51, so that region control is enabled.

FIG. 19 is a cross sectional view along a line X-X in FIG. 18 after the components in FIG. 18 are assembled. In FIG. 19, the LEDs 30 and the light guiding plate blocks 51 in a wedge-shaped cross section are disposed on the circuit board 31. A reflective sheet 23 is disposed on the underside of the light guiding plate block 51. The LED 30 is disposed as corresponding to the side surface of the light guiding plate block 51. The optical sheet group formed of three diffusion films 15 is disposed on the light guiding plate blocks 51, and the liquid crystal display panel 10 is disposed on the optical sheet group. In FIG. 19, the liquid crystal display panel 10 is illustrated in a simplified manner.

FIG. 20 is a part of a screen, and a region partitioned by dotted lines is a screen unit 100. Each of the screen units 100 corresponds to the light guiding plate block 51. In FIG. 20, three LEDs 30 correspond to each of the light guiding plate blocks 51. Therefore, region control for brightness is performed in a set of three LEDs 30. In the case where a bright pattern indicated by a circle is displayed as illustrated in FIG. 20, it is necessary to light the LEDs 30 in five regions, regions N1, N2, N3, N4, and N5, as illustrated in FIG. 21. Here, an arrow on an LED 30 expresses that the LED 30 is lit. Suppose that in the case where only the LEDs 30 in the region N1 are lit, only a rectangular region is illuminated brightly as illustrated in FIG. 22.

In the case where the circle pattern is displayed as illustrated in FIG. 20, it is inefficient for power consumption to light all of the LEDs 30 in the four regions N2 to N5 because considerably tiny areas are displayed in the regions N2 to N5. Therefore, a technique can be used, in which optical coupling between the divided light guiding plates 53 or between the light guiding plate blocks 51 illustrated in FIG. 18 or FIG. 19 is improved and light is leaked to the adjacent light guiding plate blocks 51.

However, even though such a technique is used, the reflective sheet 23 is disposed on the underside of the light guiding plate 20 in the direction opposite to a light emitting face 301 of the LED 30 as illustrated in FIG. 19, so that light leakage cannot be used in the direction opposite to the light emitting face 301 of the LED 30. In other words, even though coupling between the light guiding plate blocks 51 is improved to use light leakage on the plate-shaped light guiding plate 50, the region N4 is still dark, and a perfect circle cannot be displayed as illustrated in FIG. 23.

It is an object of the present invention to enable effective use of light from the LED 30 in a region control method in which a predetermined number of the LEDs 30 is simultaneously controlled in the liquid crystal display device. Then, the present invention is to display a predetermined screen with a fewer number of the LEDs 30 lit by excellently leaking light from a predetermined screen unit 100 to surroundings, so that it is made possible to reduce power consumption of the liquid crystal display device.

### Means for Solving the Problems

The present invention is to overcome the problems above, and main aspects are as follows. Namely, the present invention is a liquid crystal display device including a liquid crystal display panel and a backlight. The backlight includes a light guiding plate and an LED. The light guiding plate has a row of recesses arrayed at a predetermined pitch in a first direction, and the line of the recesses is arrayed at a predetermined distance in a second direction perpendicular to the first direction. The LED has a light emitting face, a top face, and a back face. The LED is housed in the recess. The back face of the LED contacts an inner wall of the recess.

Also in the case where the back face of the LED is not caused to contact the inner wall of the recess, a distance d2 between the back face of the LED and the inner wall of the recess is smaller than a distance d1 between the light emitting face of the LED and the inner wall of the recess.

Moreover, a slope is formed on a face of the recess opposite to the top face of the LED the LED in such a way that the slope is inclined downward in a direction of the back face of the LED, so that light emitted above the LED can be directed to the direction of the back face of the LED. Accordingly, the quantity of light in the direction of the back face of the LED is increased.

### Effect of the Invention

According to the present invention, light from the back face of the LED can be effectively used. Thus, the number of LEDs to be lit can be reduced in the case of performing region control, so that power consumption of a liquid crystal display device can be reduced.

### BRIEF DESCRIPTION OF THE DRAWINGS

FIG. 1 is an exploded perspective view of a liquid crystal display device;

FIG. 2 is a plan view of a light guiding plate according to the present invention;

FIG. 3 is a cross sectional view along a line A-A in FIG. 2;

FIG. 4 is a cross sectional view along a line B-B in FIG. 2;

FIG. 5 is a cross sectional view along a line C-C in FIG. 2;

FIG. 6 is a plan view of a circuit board on which LEDs are disposed;

FIG. 7 is a cross sectional view along a line D-D in FIG. 6;

FIG. 8 is a cross sectional view along a line E-E in FIG. 6;

FIG. 9 is a perspective view of the assembly of the light guiding plate and the circuit board on which the LEDs are disposed;

FIG. 10 is a perspective view of an LED;

FIG. 11 is a cross sectional view of a state in which an LED is housed in a recess on the light guiding plate according to a first embodiment;

FIG. 12 is a cross sectional view of another example in which an LED is housed in a recess on a light guiding plate according to the first embodiment;

FIG. 13 is a schematic diagram of a screen depicting an effect of the present invention;

FIG. 14 is a cross sectional view of a state in which an LED is housed in a recess on a light guiding plate according to a second embodiment;

FIG. 15 is a plan view of a light guiding plate according to a third embodiment;

FIG. 16 is a plan view of a light guiding plate expressing a problem of a fourth embodiment;

FIG. 17 is a plan view of a light guiding plate according to the fourth embodiment;

FIG. 18 is an exploded perspective view of a conventional example of a thin liquid crystal display device;

FIG. 19 is a cross sectional view along a line X-X in FIG. 18;

FIG. 20 is an exemplary display image on a screen;

FIG. 21 is an example of lit LEDs in the case where an image is displayed by general region control;

FIG. 22 is an example of a problem in the case where general region control is performed and the number of lit LEDs is reduced; and

FIG. 23 is an example of a problem in the case where region control is performed in another conventional example and the number of lit LEDs is reduced.

### MODE FOR CARRYING OUT THE INVENTION

In the following, the content of the present invention will be described in detail with embodiments.

### First Embodiment

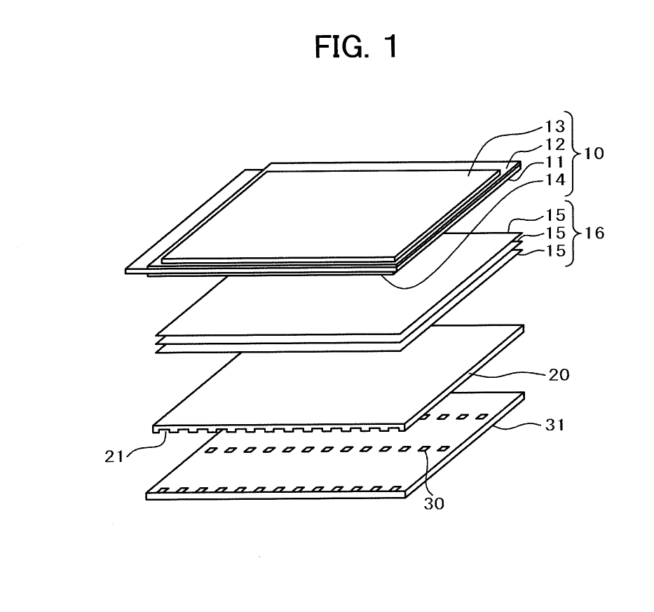

FIG. 1 is an exploded perspective view of a liquid crystal display device according to the present invention. In FIG. 1, a liquid crystal display panel 10 and a backlight are separated from each other. In FIG. 1, a TFT substrate 11 on which TFTs and pixel electrodes are disposed in a matrix configuration is bonded to a counter substrate 12 on which color filters and the like are formed through an adhesive, not illustrated. Liquid crystals, not illustrated, are sandwiched between the TFT substrate 11 and the counter substrate 12.

A lower polarizer 14 is attached on the lower side of the TFT substrate 11, and an upper polarizer 13 is attached on the upper side of the counter substrate 12. A panel in a state in which the TFT substrate 11, the counter substrate 12, the lower polarizer 14, and the upper polarizer 13 are bonded to each other are referred to as the liquid crystal display panel 10. The backlight is disposed on a back face 303 of the liquid crystal display panel 10. The backlight is formed of a light source unit and various optical components.

In FIG. 1, the backlight is configured of an optical sheet group 16, a light guiding plate 20, and a circuit board 31 on which LEDs 30 are disposed, in order close to the liquid crystal display panel 10. Three diffusion films 15 are used for the optical sheet group 16 in FIG. 1. The optical sheet group 16 sometimes includes a so-called prism sheet. In some cases, a single diffusion film 15 is provided, or two diffusion films 15 are provided.

The optical sheet group 16 is placed on the light guiding plate 20. The light guiding plate 20 serves to direct light from a large number of the LEDs 30 as a uniform surface light source to the liquid crystal display panel 10 side. The shape of the light guiding plate 20 is in a thin, flat plate shape. A large number of recesses 21 are disposed on the underside of the light guiding plate 20 in the lateral direction, and three lines of the recesses 21 are arrayed in the vertical direction. The LEDs 30 disposed on the circuit board 31 are individually inserted into the recesses 21 on the light guiding plate 20.

The circuit board 31 is disposed under the light guiding plate 20, and the LEDs 30 are disposed on the circuit board 31 in an in-line configuration in three lines in the lateral direction as corresponding to the recesses 21 on the light guiding plate 20. A description will be given on the premise that the LEDs 30 in the embodiment are white LEDs 30. However, also in the case where monochrome LEDs 30 are used, the present invention can be applicable according to the following description in the consideration of mixing three colors.

When the light guiding plate 20 is laid on the circuit board 31, the LEDs 30 disposed in an in-line configuration are fit into the recesses 21 disposed in an in-line configuration on the underside of the light guiding plate 20. With this configuration, the thickness of the liquid crystal display device can be reduced. With such a disposition of the LEDs 30, the area of a picture frame region around the display region of the liquid crystal display device can be reduced as compared with a conventional side backlight. Moreover, with such a disposition, region control on brightness is made possible on the screen.

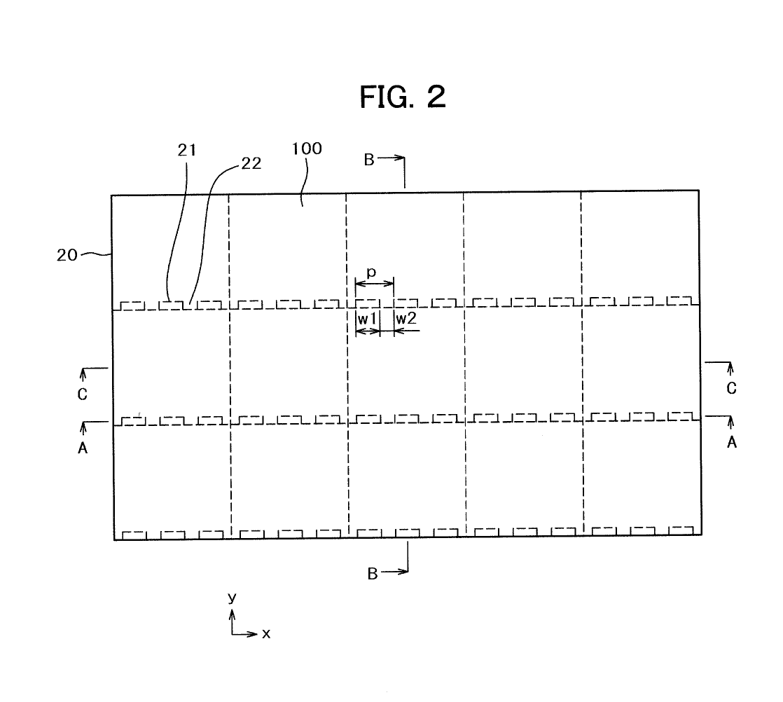

FIG. 2 is a plan view of the light guiding plate 20 used in FIG. 1. In FIG. 2, the recesses 21 disposed in an in-line configuration in an x-direction are arrayed in three lines in a y-direction. The LEDs 30 are fit into the recesses 21. Since the LEDs 30 are controlled in units of three LEDs 30, the screen can be divided into regions as illustrated in dotted lines in FIG. 2. However, since the light guiding plate 20 has no partitions corresponding to the dotted lines, even though LEDs 30 in a predetermined region are lit, the light can easily leak into the other regions.

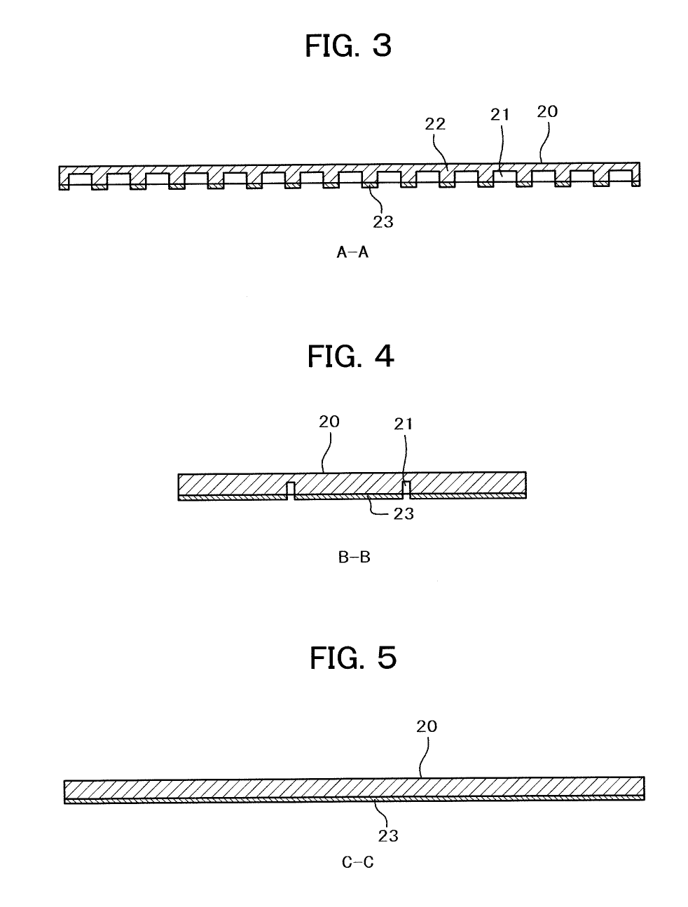

FIG. 3 is a cross sectional view along a line A-A in FIG. 2. In FIG. 3, the recesses 21 are disposed on the light guiding plate 20 at a predetermined pitch in the lateral direction, and a rib 22 is formed between the recess 21 and the recess 21. Light can also leak into the other regions through the ribs 22. FIG. 4 is a cross sectional view along a line B-B in FIG. 2. In FIG. 4, the recesses 21 that house the LEDs 30 are formed on the light guiding plate 20. FIG. 5 is a cross sectional view along a line C-C in FIG. 2. In FIGS. 3 to 5, a reflective sheet 23 is attached on the underside of the light guiding plate 20 for efficiently directing light from the LED 30 in the direction of the liquid crystal display panel 10.

Now referring to FIG. 2, the rib 22 existing between the recess 21 and the recess 21 on the light guiding plate 20 serves to cause light to enter in the y-direction between the regions expressed by dotted lines. Namely, in consideration of workability, in the case where the LEDs 30 are housed on the light guiding plate 20, it is better to form grooves in such a way that the recesses 21 are continued in the x-direction than to form the recesses 21 for the individual LEDs 30. However, since interference in the y-direction does not tend to occur when the continuous grooves are formed, the recesses 21 are formed on the light guiding plate 20 for the individual LEDs 30, and the ribs 22 can be formed.

Therefore, in the embodiment, the function of the rib 22 is important, and it is necessary to secure a predetermined value for the width of the rib 22. In FIG. 2, p=w1+w2, where a pitch between the recesses 21 in the x-direction is p, the width of the recess 21 in the x-direction is w1, and the width of the rib 22 is w2. For the width of the rib 22, desirably, w2/p is ⅓ or more when it is possible on design, although it depends on the number of LEDs 30 disposed per screen unit 100 or on the pitch of the LED 30.

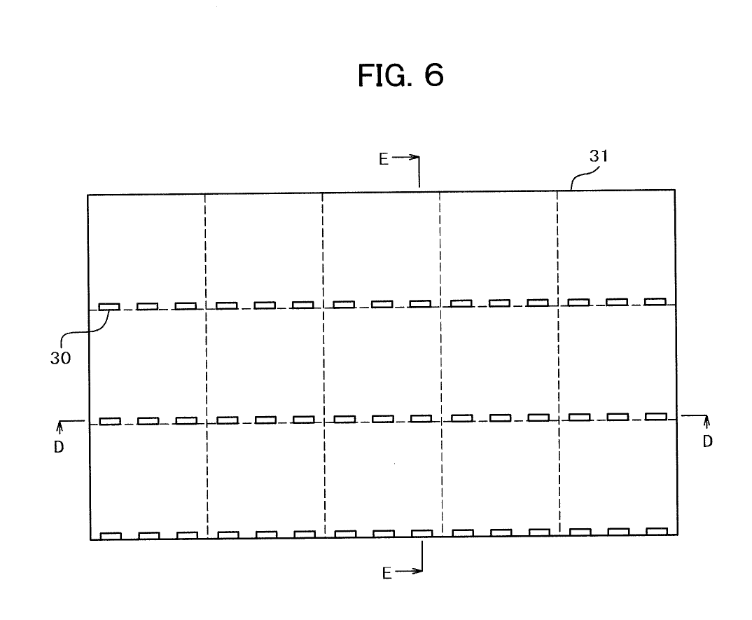

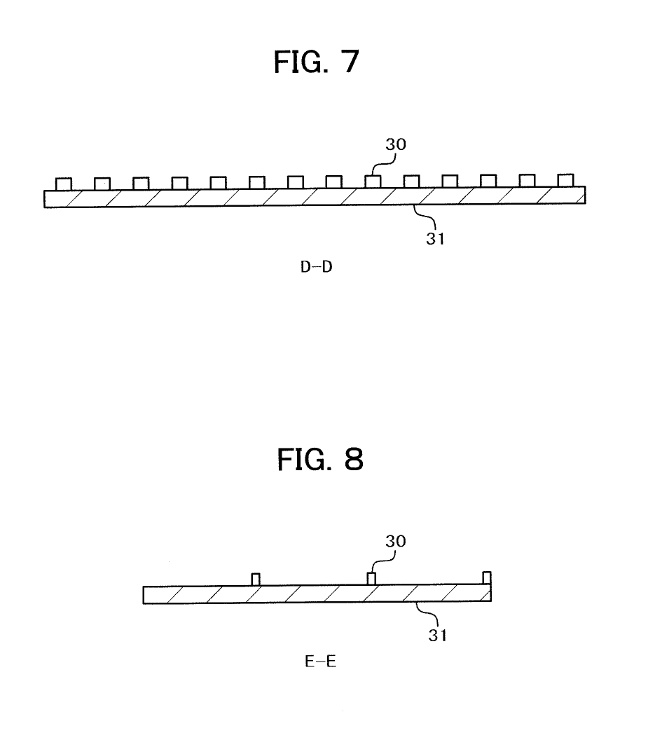

FIG. 6 is a plan view of the circuit board 31 on which the LEDs 30 are mounted, FIG. 7 is a cross sectional view along a line D-D in FIG. 6, and FIG. 8 is a cross sectional view along a line E-E in FIG. 6. In FIG. 6, the LEDs 30 disposed in an in-line configuration are arrayed in three lines. The LEDs 30 are inserted into the recesses 21 on the light guiding plate 20. In FIG. 6, the LEDs 30 are controlled in units of three LEDs 30. Dotted lines in FIG. 6 express the regions controlled by three LEDs 30.

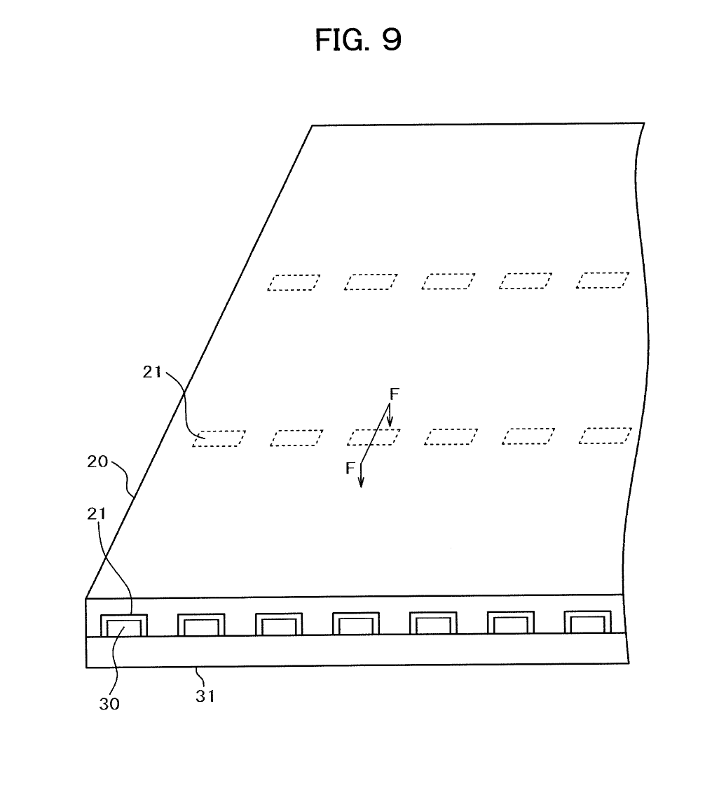

FIG. 9 is a perspective view of a state in which the light guiding plate 20 illustrated in FIG. 2 is assembled with the circuit board 31 illustrated in FIG. 6. In FIG. 9, the LEDs 30 on the circuit board 31 are inserted into the recesses 21 on the light guiding plate 20. As illustrated in FIG. 9, in consideration of the disposition accuracy of the LEDs 30 on the circuit board 31, the disposition accuracy of the recesses 21 on the light guiding plate 20, and the assembly accuracy of the circuit board 31 with the light guiding plate 20, the size of the recess 21 is formed larger than the size of the LED 30.

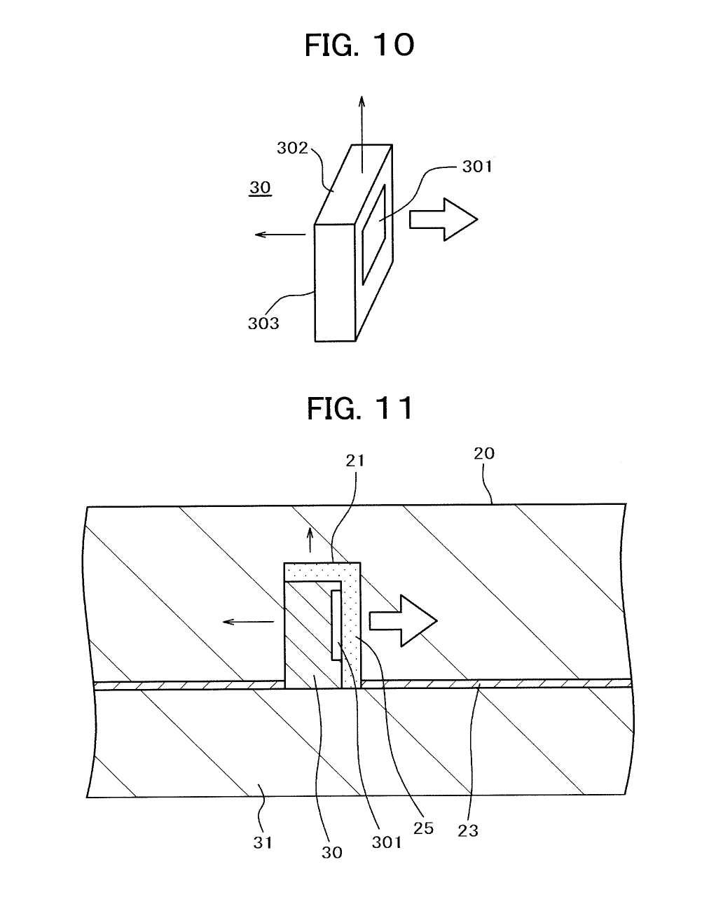

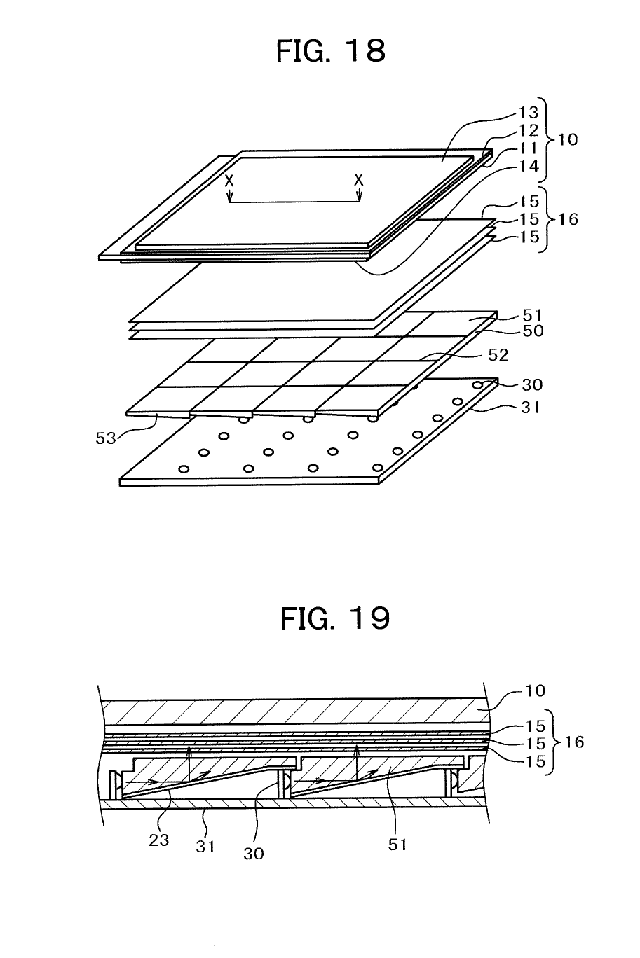

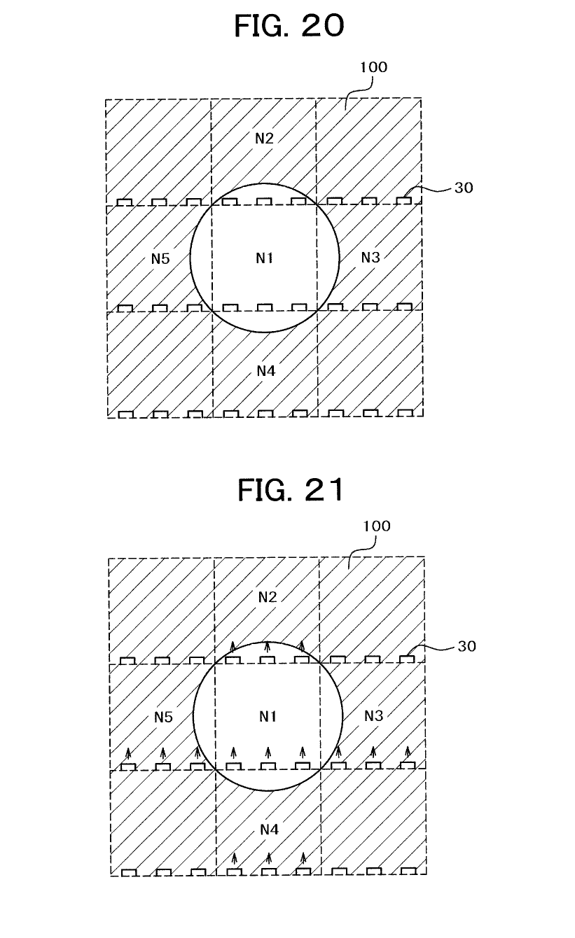

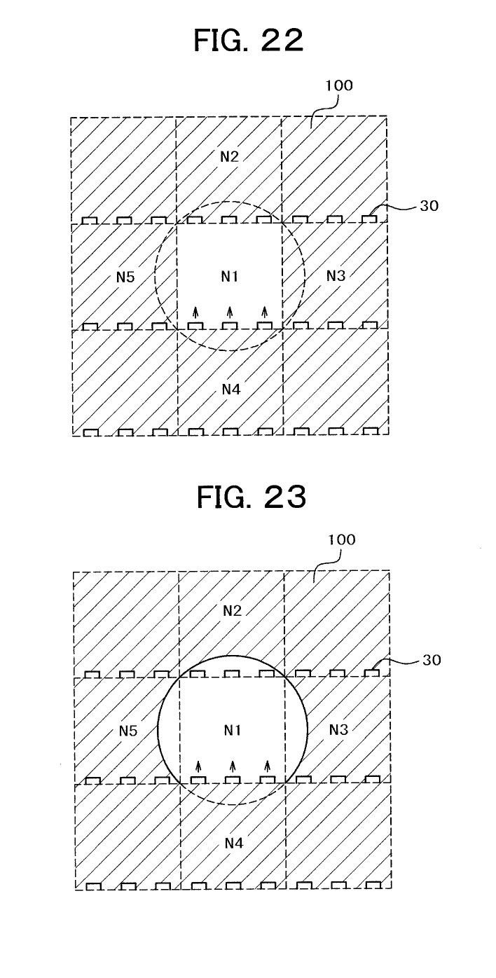

FIG. 10 is a perspective view of the LED 30. In FIG. 10, an LED chip, not illustrated, is disposed in the LED 30. As indicated by a blank arrow, light from the LED chip is mainly externally emitted from a light emitting face 301 of the LED 30. However, since the light of the LED chip is considerably strong, the light is slightly emitted from a top face 302 or the back face 303 of the LED 30. Conventionally, light emitted from the back face 303 of the LED 30 was completely blocked and wasted, as illustrated in FIG. 18. In the embodiment, the light emitted from the back face 303 of the LED 30 is also used to reduce power consumption.

FIG. 11 is a cross sectional view along a line F-F in FIG. 9, and is a diagram of a feature of the embodiment. In FIG. 11, the LED 30 is disposed on the circuit board 31. The reflective sheet 23 is disposed on the underside of the light guiding plate 20. The LED 30 is housed in the recess 21 on the light guiding plate 20. In order to accommodate variations in manufacture accuracy, the recess 21 on the light guiding plate 20 is formed larger than the LED 30. The feature of the embodiment is in that the back face 303 of the LED 30 contacts the inner wall of the recess 21 on the light guiding plate 20. In other words, in the embodiment, light from the back face 303 of the LED 30 is positively used, so that the brightness of the screen can be improved, and the power consumption of the backlight can be reduced.

Since the light from the back face 303 of the LED 30 is weak, the back face 303 of the LED 30 is brought as close to the wall of the recess 21 on the light guiding plate 20 as possible for the maximum use of the light. On the other hand, a resin having a refractive index close to the refractive index of the light guiding plate 20 is filled in the recess 21 on the light guiding plate 20, so that a reduction in the intensity of light on the light emitting face 301 side of the LED 30 is prevented. It is noted that the coupling effect can be increased when the refractive index of the resin is greater than the refractive index of air. However, it is not essential to fill a coupling resin.

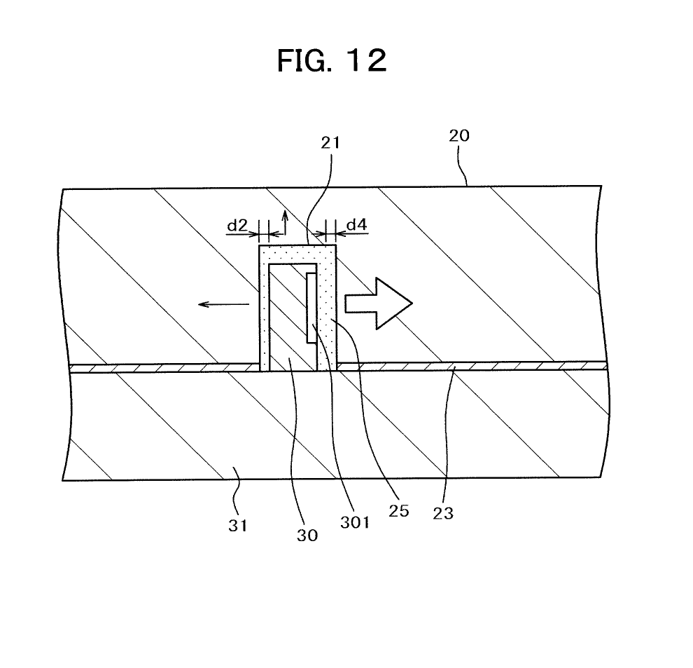

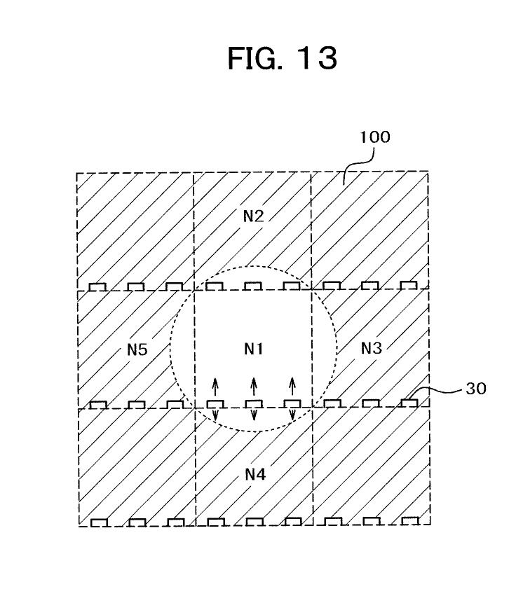

FIG. 12 is another form of the embodiment. In the case where it is difficult to cause the back face 303 of the LED 30 to contact the inner wall of the recess 21 on the light guiding plate 20, a distance d2 is formed between the back face 303 of the LED 30 and the inner wall of the recess 21. However, in this case, d2 is smaller than a distance d1 between the light emitting face 301 of the LED 30 and the inner wall of the recess 21. The distance between the back face 303 of the LED 30 and the inner wall of the recess 21 is not the same as the distance between the light emitting face 301 of the LED 30 and the inner wall of the recess 21 in a plane. In this case, suppose that d1 and d2 take a minimum value. Moreover, in this case, desirably, a resin for optical coupling is also filled between the inner wall of the recess 21 on the light guiding plate 20 and the back face 303 of the LED 30. However, a coupling resin is not essential.

As described above, light from the back face 303 of the LED 30 is also used, so that it is also possible in region control to leak light into regions in which display using light leakage has not been possible so far. FIG. 13 is a diagram illustrating this light leakage. In FIG. 13, only three LEDs 30 in a region N1 are lit. The light in the region N1 can easily enter regions N2, N3, and N5 because there are no partitions between the regions.

Conventionally, it was not possible that light from N1 entered the region N4. However, with the embodiment as illustrated in FIGS. 11 and 12, since light from the back face 303 of the LED 30 is used, light from the LEDs 30 used in the region N1 can also be used for the region N4. As a result, as illustrated in FIG. 13, by lighting only three LEDs 30 for the region N1, light can be applied to the regions N2, N3, N4, and N5, and a circle pattern can be displayed with the three LEDs 30 for the region N1 as illustrated in FIG. 13. In FIG. 13, small arrows from the LEDs 30 indicate light from the back faces 303 of the LEDs 30.

As described above, according to the embodiment, a fewer number of the LEDs 30 are lit to display the same pattern, so that a liquid crystal display device with smaller energy consumption can be implemented.

### Second Embodiment

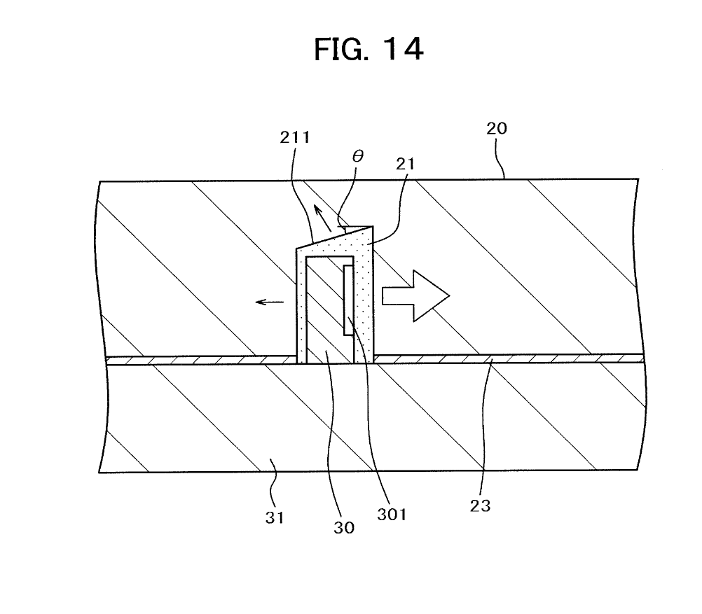

FIG. 14 is a cross sectional view of a second embodiment of the present invention. FIG. 14 is a cross sectional view along a line F-F in FIG. 9, and corresponds to FIGS. 11 and 12 in the first embodiment. In FIG. 14, it is similar to the first embodiment that an LED 30 disposed on a circuit board 31 is housed in a recess 21 on a light guiding plate 20. The feature of the embodiment lies in that the top face of the recess 21 on the light guiding plate 20 is formed to have an inclined plane 211.

The top face of the recess 21 is formed to have the inclined plane 211, so that light emitted from a top face 302 of the LED 30 is directed to the direction of a back face 303 of the LED 30 because of a lens effect. Of course, although all the quantity of light from the top face 302 of the LED 30 is not enabled to be directed to the back face 303 of the LED 30, only a part of the quantity of light is directed to increase the quantity of light directed to the direction of the back face 303 of the LED 30.

In the embodiment, since the lens effect is produced using a difference between the refractive index of air and the refractive index of the light guiding plate 20, it is unnecessary to fill a resin for optical coupling between the LED 30 and the wall surface of the recess 21 on the light guiding plate 20. On the contrary, according to the embodiment, since the quantity of light directed to the direction of the back face 303 of the LED 30 can be increased without using a coupling resin 25, workability is excellent. It is noted that also in this case, the back face 303 of the LED 30 may contact the inner wall of the recess 21 on the light guiding plate 20. Moreover, even in the case where the back face 303 of the LED 30 does not contact the inner face of the recess 21 on the light guiding plate 20, desirably, a distance between the back face 303 of the LED 30 and the inner wall of the recess 21 is smaller than a distance between the light emitting face 301 of the LED 30 and the inner wall of the recess 21.

### Third Embodiment

It is an object of the present invention to obtain equivalent brightness even though the number of LEDs 30 to be lit is reduced in the case of performing region control. To this end, it is important to positively leak light between regions. Light does not tend to leak particularly between regions B1, B2, and B3 partitioned by lines of recesses 21. Namely, light does not tend to leak in the y-direction.

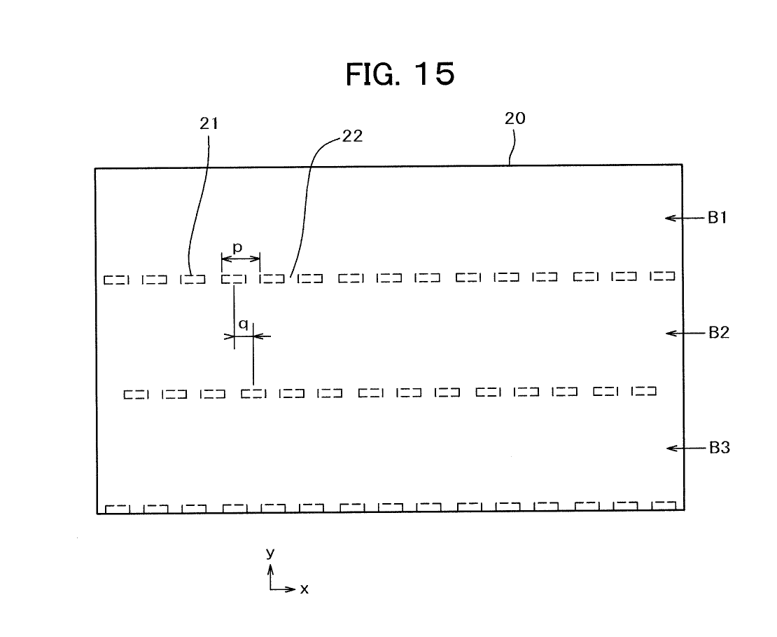

In the embodiments described above, in order to positively cause this optical interference in the y-direction, the rib 22 is disposed between the recess 21 and the recess 21 on the light guiding plate 20 in the x-direction as described in FIG. 2. Moreover, in this embodiment, in order to further increase the effect of the rib 22, recesses 21 in the x-direction are disposed in such a way that the recesses 21 are displaced from each other in the y-direction as illustrated in FIG. 15. Namely, in this embodiment, LEDs 30 in a certain line and LEDs 30 in an adjacent line are arrayed in a staggered configuration in the x-direction. In FIG. 15, for a displacement amount q between the recesses 21, q/p=½, where a pitch between the recesses 21 is p.

In FIG. 15, in the case where the recesses 21 are displaced in the x-direction between lines contiguous to each other above and below, the position of the LED 30 is different from the position of the end portion of a light guiding plate 20 at the end portion of the light guiding plate 20. In displaying, brightness at the end portion is not important generally. However, in the case where brightness at the end portion is also demanded to be uniform, it is sometimes necessary to reduce q/p described above. Also in this case, desirably, around q/p=⅓ is secured.

Thus, the effect of the rib 22 between the recesses 21 can be further improved, and interference in the y-direction can be more frequently caused. Accordingly, many image patterns can be displayed by lighting a fewer number of the LEDs 30.

### Fourth Embodiment

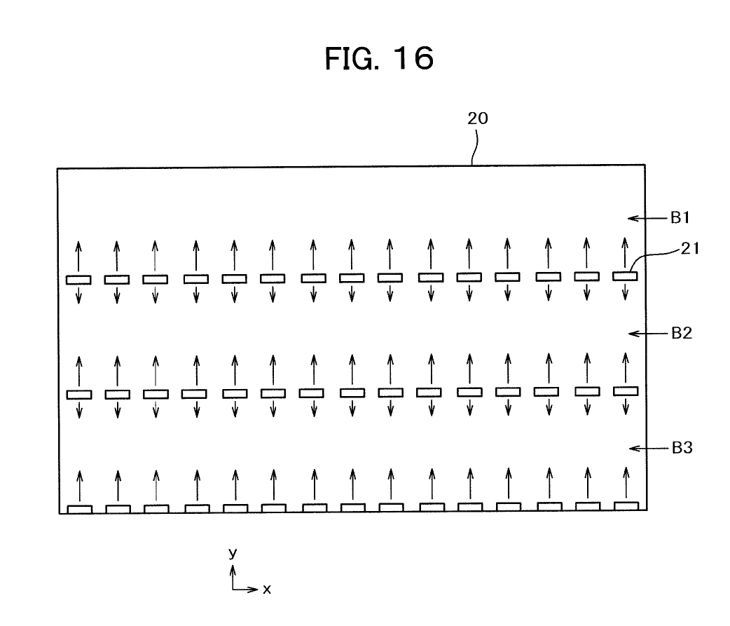

The embodiments described above aim to save power of the backlight by also positively using light from the back face 303 of the LED 30. Now, in the case where recesses 21 on a light guiding plate 20, that is, LEDs 30 are disposed as in FIG. 16, when a white color is displayed, light from the LEDs 30 is expressed by arrows. Here, a long arrow expresses light from a light emitting face 301 of the LED 30, and a short arrow expresses light from a back face 303 of the LED 30. Light only from the light emitting face 301 of the LED 30 enters a region expressed by B1 in FIG. 16, whereas the total of light from the light emitting face 301 of the LED 30 and light from the back face 303 of the LED 30 is applied to regions expressed by B2 and B3. This means that in the case where a white color is displayed, brightness is sometimes reduced in the region expressed by B1 than in the regions expressed by B2 and B3.

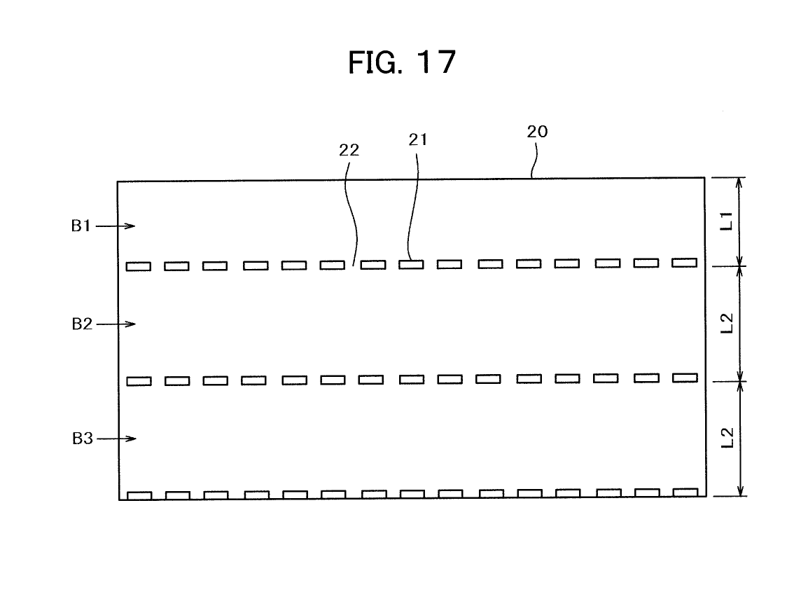

In order to take measures against this problem, in the embodiment, a width L1 of the region B1 is made smaller than a width L2 of the regions B2 and a width L2 of B3 as illustrated in FIG. 17. Namely, L1<L2. The difference between the width of B1 and the widths of B2 and B3 is determined according to the percentage between the quantity of light from the back face 303 of the LED 30 and the quantity of light from the light emitting face 301 of the LED 30. With this configuration, region control can be performed using a fewer number of the LEDs 30, and a brightness variation can also be reduced in the case where a white color is displayed.

### DESCRIPTION OF REFERENCE NUMERALS AND SIGNS

10 Liquid crystal display panel
11 TFT substrate
12 Counter substrate
13 Upper polarizer
14 Lower polarizer
15 Diffusion film
16 Optical sheet group
20 Light guiding plate
21 Recess
22 Rib
23 Reflective sheet
25 Coupling resin
30 LED
31 Circuit board
50 Wedge-shaped light guiding plate
51 Light guiding plate block
52 Groove
53 Divided light guiding plate
100 Screen unit
   211 Inclined plane of recess
301 LED light emitting face
302 LED top face
303 LED back face

1. A liquid crystal display device comprising a liquid crystal display panel and a backlight,
wherein the backlight includes a light guiding plate and an LED;
the light guiding plate has a row of recesses arrayed at a predetermined pitch in a first direction, and the line of the recesses is arrayed at a predetermined distance in a second direction perpendicular to the first direction;
the LED has a light emitting face, a top face, and a back face;
the LED is housed in the recess; and
the back face of the LED contacts an inner wall of the recess.

2. The liquid crystal display device according to claim 1,
wherein a rib is provided between the recesses; and
w2/p is ⅓ or more, where a pitch between the recesses in the first direction is defined as p, a width of the recess in the first direction is defined as w1, and a width w2 of the rib is defined as w2=p−w1.

3. The liquid crystal display device according to claim 1, wherein an optical coupling of a resin to the LED is disposed in the recess.

4. A liquid crystal display device comprising a liquid crystal display panel and a backlight,
wherein the backlight includes a light guiding plate and an LED;
the light guiding plate has a row of recesses arrayed at a predetermined pitch in a first direction, and the line of the recesses is arrayed at a predetermined distance in a second direction perpendicular to the first direction;
the LED has a light emitting face, a top face, and a back face;
the LED is housed in the recess; and
d1>d2, where a distance between the light emitting face of the LED and an inner wall of the recess is defined as d1, and a distance between the back face of the LED and the inner wall of the recess is defined as d2.

5. The liquid crystal display device according to claim 4,
wherein w2/p is ⅓ or more, where a pitch between the recesses in the first direction is defined as p, a width of the recess in the first direction is defined as w1, and a width w2 of a rib is defined as w2=p−w1.

6. The liquid crystal display device according to claim 4, wherein an optical coupling of a resin to the LED is disposed in the recess.

7. A liquid crystal display device comprising a liquid crystal display panel and a backlight,
wherein the backlight includes a light guiding plate and an LED;
the light guiding plate has a row of recesses arrayed at a predetermined pitch in a first direction, and the line of the recesses is arrayed at a predetermined distance in a second direction perpendicular to the first direction;
the LED has a light emitting face, a top face, and a is back face;
the LED is housed in the recess; and
a face of the recess opposite to the top face of the LED has a slope inclined downward in a direction of the back face of the LED.

8. The liquid crystal display device according to claim 7, wherein an angle of the slope is an angle of two degrees or more.

9. A liquid crystal display device comprising a liquid crystal display panel and a backlight,
wherein the backlight includes a light guiding plate and an LED;
the light guiding plate has a first line in which recesses are arrayed at a predetermined pitch in a first direction and a second line in which recesses are arrayed at a predetermined pitch in the first direction, and the first line and the second line are formed apart in a direction perpendicular to the first direction;
the recesses in the first line and the recesses in the second line are displaced from each other in the first direction; and
the LED is housed in the recess.

10. The liquid crystal display device according to claim 9, wherein an amount of displacement in the first direction between the recesses in the first line and the recesses in the second line is one third or more of the predetermined pitch.

11. The liquid crystal display device according to claim 9, wherein an amount of displacement in the first direction between the recesses in the first line and the recesses in the second line is a half of the predetermined pitch.

12. A liquid crystal display device comprising a liquid crystal display panel and a backlight,
wherein the backlight includes a light guiding plate and an LED;
the light guiding plate includes a row of recesses arrayed at a predetermined pitch in a first direction;
the line of the recesses is disposed in a second direction perpendicular to the first direction at a distance L2;
the light guiding plate includes an edge with the line of the recesses and an edge without the line of the recesses;
L1<L2, where a distance between the edge of the light guiding plate without the line of the recesses and the line of the recesses closest to the edge in the second direction is L1; and
the LED is housed in the recess.
